(19) United States
(12) Patent Application Publication
(10) Pub. No.: US 2020/0015498 A1
(43) Pub. Date: Jan. 16, 2020

(54) ANIMAL FEED WITH BETA ADRENERGIC AGONIST AND ISOQUINOLINE ALKALOID

(71) Applicant: Hermann ROTH, Eltville (DE)

(72) Inventor: Hermann ROTH, Eltville (DE)

(21) Appl. No.: 16/309,222

(22) PCT Filed: Apr. 4, 2017
(86) PCT No.: PCT/EP2017/057959

§ 371 Date: Dec. 12, 2018

(51) Int. Cl. A23K 20/142; A23K 10/30; A23K 50/30

(52) U.S. Cl. CPC A23K 20/142; A23K 50/30; A23K 10/30

(57) ABSTRACT

The invention relates to an animal feed or an animal feed supplement comprising a combination of an isoquinoline alkaloid and a beta adrenergic agonist.

### FIELD OF THE INVENTION

The present invention relates generally to animal feed and feed supplements and more particularly to methods to improve feed efficiency and meat quality, in particular to improve the deposition of lean meat and protein and to reduce the deposition of fat in farm animals.

### BACKGROUND AND RELATED ART

Ractopamine and other beta adrenergic agonists are feed additives commonly used to promote growth, leanness and meat quality in animals raised for their meat. For example, ractopamine is the active ingredient in products known as Paylean for swine and Optaflexx for cattle (trade marks of Eli Lilly & Co., USA).

An adrenergic agonist is a substance that stimulates a response from the adrenergic receptors. Beta adrenergic agonists stimulate β1 and/or β2 adrenergic receptors.

When used as a food additive, ractopamine and other beta adrenergic agonists are distributed via the blood to the muscle tissues. Like other beta adrenergic agonists, ractopamine triggers a cascade of metabolic processes to increase protein synthesis, which results in increased muscle fiber size, an increased rate of weight gain, improved feed efficiency, and increased carcass leanness in finishing farm animals, in particular swine. Its use in finishing swine yields additional lean pork and improves feed efficiency.

These days, consumers tend to prefer lean meat to fat meat. Therefore, the leanness of meat is considered as a quality indicator. The prices per kg meat that can be achieved for lean meat are significantly higher than the prices achievable for fat meat. Beta adrenergic agonists like ractopamine are able to transform fat tissue into lean meat tissue. They are therefore used for increasing the meat leanness and thus also for increasing the price that can be achieved on the market.

A prerequisite for the physiological effectiveness of beta adrenergic agonists like ractopamine is that a sufficiently high amount of protein and essential amino acids circulate in the blood of the animals during “beta adrenergic agonist” treatment. Therefore, animals treated with ractopamine or similar substances need feed that comprises considerably more proteins than the feed of untreated animals. The additional proteins in the feed are needed for transforming the energy of the fat tissue, which is metabolised by the beta adrenergic agonist, into lean meat tissue. Thus, in order to successfully turn fat tissue into lean meat tissue, the animal feed needs to be enriched with additional proteins, e.g. by increasing the soybean meal content in the animal feed or by increasing the inclusion of synthetic essential amino acids as Lysine, Threonin or Methionin compared to the untreated feeds. The application of ractopamine alone will not result in a significant improvement of the meat quality as the transformation of fat tissue into lean meat tissue will fail. Thus, protein-rich or protein-enriched or amino acid enriched animal feed must be provided during ractopamine treatment to achieve the desired effect.

The use of beta adrenergic agonists therefore requires an increased proportion of protein content in the feed. Since protein-rich animal feed is about 3 to 4 times more expensive than conventional, carbohydrate-rich feed (corn as a classical carbon-hydrate-rich energy feed cost approximately 130 USD per ton, soybeans as a protein-rich feed cost about 400 USD per ton), the increase of the protein content in the formulation of the feed results in a much more expensive final animal feed mixture. The increased animal feed costs significantly reduce the profit gain achieved by the ractopamin-triggered transformation of fat meat into lean meat.

### SUMMARY

It is an objective of the present invention to provide for an improved animal feed, animal feed supplement and method for decreasing the amount of protein that needs to be fed to an animal during the application of a beta adrenergic agonist to enable the beta adrenergic agonist to become physiologically effective as specified in the independent claims. Embodiments of the invention are given in the dependent claims. Embodiments of the present invention can be freely combined with each other if they are not mutually exclusive.

In one aspect, the invention relates to an animal feed comprising a combination of an isoquinoline alkaloid and a beta adrenergic agonist.

In a further aspect, the invention relates to an animal feed supplement comprising a combination of an isoquinoline alkaloid and a beta adrenergic agonist.

Said features may be advantageous for multiple reasons: the physiologically active substances, isoquinoline alkaloid and the beta adrenergic agonist, can be provided easily via the feed. Supplementing the feed not only with the beta adrenergic agonist but also with the isoquinoline alkaloid may have the benefit that the protein concentration in the animal feed can be lower than the protein concentration necessary for enabling the beta adrenergic agonist based transformation of fat tissue into lean meat.

In a further beneficial aspect, supplementing the animal feed not only with the beta adrenergic agonist but also with the isoquinoline alkaloid may have the benefit that the growth and meat production rate of the animal is accelerated by both substance groups in a synergistic manner. A general growth-promoting effect of isoquinoline alkaloids and a lean-meat growth promoting effect of the beta adrenergic agonist as such are known. However, it has been surprisingly observed that the combined positive effect of isoquinoline alkaloid and the beta adrenergic agonist on the growth rate is larger than the additive growth promoting effect. In particular, it has been observed that the gain in lean meat is significantly higher than the gain that would be expected by the combined individual effects of both substance classes.

Without the intention to be bound by any theory, applicant believes that the isoquinoline alkaloid modifies the protein and/or fat metabolism involved in providing the amino acids and the energy for the generation of lean meat in response to the application of beta adrenergic agonists such that the amino acids are more efficiently mobilized or more efficiently used for generating the lean meat. Thus, the combination of a beta adrenergic agonist and an isoquinoline alkaloid result in an improved conversion of protein and amino acids in the animal feed into lean meat and results in a strongly increased efficacy of the beta adrenergic agonist. Accordingly, in order to achieve a particular gain in lean meat per time in response to the application of a defined amount of a beta adrenergic agonist, the presence of isoquinoline alkaloid in the animal feed allows to reduce the protein and amino acid fraction of the animal feed compared to the standard protein enriched feed formulation advise given by the suppliers of the beta adrenergic agonist and thus allows reducing costs without a negative impact on the effect of the beta adrenergic agonist's improved meat quality traits. Thus, the extra amount of protein that needs to be provided during ractopamine treatment in addition to the protein amount of the “standard” animal feed may be reduced by up to 50%. For example, the isoquinoline alkaloids may improve the absorbtion or metabolic processing of amino acids via the intestines of the animals, thereby improving the physiologic availability of amino acids contained in the animal feed. Alternatively, the isoquinoline alkaloids may prevent degradation or secretion of amino acids. In any case, the observed effect of a combined application of a beta adrenergic agonist and an isoquinoline alkaloid is that less “protein-rich” animal feed is required for achieving a desired gain in lean meat. Accordingly, if a beta adrenergic agonist is provided in combination with a protein-enriched feed and an isoquinoline alkaloid, the lean meat gain is significantly larger compared to providing the protein-enriched feed and the beta adrenergic agonist alone. Several experiments have surprisingly shown that the weight gain of the animal per time and the transformation of fat tissue into lean meat tissue is boosted synergistically.

The synergistic improvement of protein and amino acid utilization and weight gain may imply that the gain in total body weight or in lean-meat content is increased more strongly than by the factor that would be expected by applying ractopamine as a component of an animal feed with standard protein content on the one hand and the isoquinoline alkaloid on the other hand. The synergistic effect in particular relates to the growth of lean meat as lean meat contains less energy (fat) than meat with higher fat levels and as such, the feed conversion rate (FCR) and weight gains of lean meat are usually favourable compared to a meat more rich in fat.

According to embodiments, the animal feed or the animal feed supplement is for use in decreasing the amount of protein that needs to be fed to an animal during the application of a beta adrenergic agonist to enable the beta adrenergic agonist to become physiologically effective. In other words, the animal feed or the animal feed supplement is for use in modifying the metabolism (presumably the protein and/or amino acid metabolism) of the animal such that the amount of protein that needs to be fed to an animal during the application of a beta adrenergic agonist to enable the beta adrenergic agonist to become physiologically effective is decreased.

According to embodiments, the animal feed or the animal feed supplement is for use in increasing the growth rate of the animals, whereby the isoquinoline alkaloid and the beta adrenergic agonist boost the growth rate synergistically.

Synergistic growth stimulation as used herein implies that the increase in the growth rate caused by a combined application of isoquinoline alkaloid and the beta adrenergic agonist is larger than the sum of the growth rate increase caused by the isoquinoline alkaloid and the beta adrenergic agonist individually.

According to embodiments, the isoquinoline alkaloid is selected from a group comprising sanguinarine, chelerythrine, chelirubin, sanguirubin, chelilutin, sanguilutin, berberin, protopin, allocryptopin and physiologically acceptable salts of these compounds. According to embodiments, the isoquinoline alkaloids are Benzophenanthridin alkaloids.

According to alternative embodiments, the isoquinoline alcalid(s) are added to the animal feed or animal feed supplement in a purified form.

According to embodiments, the isoquinoline alkaloids or isoquinoline alkaloid derivatives are contained in the animal feed or animal feed supplement in the following ratios of amounts (by weight of the total isoquinoline content of the feed or feed supplement): sanguinarine: 35 to 100 (purified) %; chelerythrine: 20 to 100 (purified) % by weight; chelirubin: 3 to 5% by weight; sanguirubin: 0 to 2% by weight; chelilutin: 3 to 40% by weight; sanguilutin: 0 to 15% by weight.

A physiologically acceptable isoquinoline alkaloid salt can be, for example, sanguinarine chloride and this could be used alone at an amount of 100% of the total sum of the isoquinoline alkaloids supplied into such feed. The animal feed can comprises the alkaloids in the form of an alkaloid rich extract which containes the above said alkaloids of sanguinarine in combination with chelerythrin or either one or the other of the two alkaloids in an isolated 100% form as a single source of the isoquinoline alkaloids in an amount of 0.01 to 500 mg/kg feed, preferably 0.1 to 150 mg/kg feed, e.g. an amount of 0.1 to 5 mg isoquinoline alkaloid per kg of the animal feed.

According to embodiments, the animal feed or animal feed supplement comprises a plant extract of a Sanguinaria species, e.g. an extract of Sanguinaria Canadensis. In addition, or alternatively, the animal feed or animal feed supplement comprises a plant extract of a Macleaya species, in particular Macleaya cordata. For example, the plant extract can comprise a mixture of two or more of the isoquinoline alkaloids or isoquinoline alkaloid salts mentioned above.

Sanguinaria Canadensis alkaloids can be obtained by an acid-base extraction made from the powdered rhizomes in methanol and precipitated with zinc chloride therefrom. The sanguinarine can be obtained from the extracts as a pure substance by recrystallization using NaCl and HCl, treated with NH4OH and then precipitated twice with HCl. Alternatively, the dried and powdered rhizomes of Sanguinaria canadensis can be subjected to a hydro-alcoholic extraction. The solvent is removed by vacuum distillation. In this case, a concentrated resin-like, tough-viscous extract of reddish-brown color and a sweet, tobacco-like odor is obtained. This extract is freeze-dried for 24 hours and then mixed with corn starch as a binder and carrier medium in a ratio of about 1:4.

According to embodiments, the beta adrenergic agonist is ractopamin or zilpaterol. In addition, or alternatively, other beta adrenergic agonists may likeweise be used.

For example, the beta adrenergic agonist may be a “β1 agonist”. Some examples for [β1 agonist are: Denopamine, Dobutamine, Dopexamine (β1 and β2), Epinephrine (non-selective), Isoprenaline (INN), isoproterenol (USAN) (β1 and β2), Prenalterol, Xamoterol.

According to other examples, the beta adrenergic agonist may be a “β2 agonist”. Some examples for β2 agonist are: Arformoterol, Buphenine, Clenbuterol, Dopexamine (β1 and β2), Epinephrine (non-selective), Fenoterol, Formoterol, Isoetarine, Isoprenaline (INN), isoproterenol (USAN) (β1 and β2), Levosalbutamol (INN), levalbuterol (USAN), Orciprenaline (INN), metaproterenol (USAN), Pirbuterol, Procaterol, Ritodrine, Salbutamol (INN), albuterol (USAN), Salmeterol, Terbutaline.

According to still other embodiments, the beta adrenergic agonist is one of Arbutamine, Befunolol, Bromoacetylalprenololmenthane, Broxaterol, Cimaterol, Cirazoline, Etilefrine, Hexoprenaline, Higenamine, Isoxsuprine, Mabuterol, Methoxyphenamine, Oxyfedrine, Ractopamine, Reproterol, Rimiterol, Tretoquinol, Tulobuterol, Zilpaterol, or Zinterol.

According to embodiments, the animal feed or animal feed supplement has a weight ratio of ractopamine to the one or more isoquinoline alkaloids (e.g. sanguinarine) of from 150:1 to 0.4:1.

According to embodiments, the animal feed is fed to the animals in an amount such that the recommended daily dosage per animal of the animal feed comprises an intake of isoquinoline alkaloid (s) or salts of the isoquinoline alkaloids per day of 0.01 mg/day (e.g. for broilers) to 0.5 mg/day (e.g. for pigs) or 5 mg/day (e.g. for cattle).

According to embodiments, the animal feed comprises an amount of 2 to 15 mg of the beta adrenergic agonist per kg of the animal feed, in particular 6 to 9 mg of the beta adrenergic agonist per kg of the animal feed.

Typical animal feed contains corn in an amount of 0%-50% by weight of the animal feed. Higher corn levels are unfavouralbe, in particular at levels above 50-70%, in particular when a beta adrenergic agonist is added to the feed, because those relatively high corn levels above 50% reduce the overall protein level in the feed formulation.

According to embodiments, the animal feed comprises corn in an amount of 51% -80%, in particular between 65 and 70% by weight of the animal feed. A relatively high concentration of corn of up to 75% in a feed containing the beta adrenergic agonist and the isoquinoline alkaloids may be advantageous as it is higher than the corn concentration of feed typically used while applying a beta adrenergic agonist to a farm animal This high corn concentration is—due to its low protein content—typically not suitable for enabling the desired effect of beta adrenergic agonists applied alone (under the absence of the alkaloids). However, applicant has surprisingly observed that this high concentration of corn can enable the beta adrenergic agonist to become effective and transform fat meat tissue into lean meat tissue provided that an isoquinoline alkaloid is fed to the animals in addition to the beta adrenergic agonist. As corn is a comparatively cheap feed component with comparatively low protein content, the costs per ton of the animal feed during beta adrenergic agonist treatment containing a higher corn composition may be reduced.

According to embodiments, the animal feed contains soybean meal in an amount of not more than 14% by weight of the animal feed.

In some embodiments, the animal feed contains soybean meal in an amount of not more than 12% by weight of the animal feed.

According to embodiments, the animal feed contains soybean meal in an amount of 10%-12%, in particular 10-11% by weight of the animal feed.

Said reduced soybean meal concentrations may be advantageous as they are lower than the soybean meal concentration of animal feed typically used while applying a beta adrenergic agonist alone to a farm animal (typical soy bean content in this case is in the range of 13 to 17% and up to 20%. The low soybean meal concentration according to embodiments of the invention is typically not sufficient for enabling the desired effect of beta adrenergic agonists applied alone (under the absence of the an isoquinoline alkaloid). However, applicant has surprisingly observed that this low soybean meal concentration is sufficient to enable the beta adrenergic agonist to become effective and transform fat meat tissue into lean meat tissue provided that an isoquinoline alkaloid is fed to the animals in addition to the beta adrenergic agonist. As soybean meal is a comparatively expensive feed component, the costs for the animal feed during beta adrenergic agonist treatment may be reduced.

According to embodiments, the animal feed contains DDGS (Dried Distillers Grains with Solubles) in an amount of 10%-22%, in particular 16% to 20% by weight of the animal feed.

According to embodiments, the animal feed comprises protein in an amount of less than 16.5% by weight of the animal feed, preferentially less than 15.8% by weight of the animal feed. According to further embodiments, the animal feed comprises protein in an amount less than 15.5% or even less than 15% by weight of the animal feed. The protein can be contained in the feed e.g. in the form of crude protein (CP).

Said reduced protein concentrations may be advantageous as it is lower than the protein concentration of animal feed typically used while applying a beta adrenergic agonist to a farm animal. This low protein concentration is typically not sufficient for enabling the desired effect of beta adrenergic agonists applied alone (under the absence of the isoquinoline alkaloid). However, applicant has surprisingly observed that this low protein concentration is sufficient to enable the beta adrenergic agonist to become effective and transform fat meat tissue into lean meat tissue provided that an isoquinoline alkaloid is fed to the animals in addition to the beta adrenergic agonist. As protein-rich animal feed is comparatively expensive, the costs for the animal feed during beta adrenergic agonist treatment may be reduced if the application of the isoquinoline alkaloid associated with a reduced protein content in the said feed is combined with the application of the beta adrenergic agonist.

In a further beneficial aspect, food intake was observed to be reduced as a result of administrating the beta adrenergic agonist, thereby further reducing the costs for finishing the tested animals.

Due to the metabolic changes that occur when ractopamine or other beta adrenergic agonists are fed, nutritional requirements of the animals change. To account for the increased protein deposition, dietary protein levels and also dietary amino acid levels are increased in state of the art approaches for finishing pigs and other animals.

Several standard animal feeds (without any beta adrenergic agonist) comprise a defined amount of the essential amino acid lysine in in an amount of 0.75 to 0.8% without any other additive. When ractopamine is added to the food of finished pigs, state of the art approaches recommended to increase the lysine content. According to the scientific literature and the recommendations of commercial animal feed suppliers, 1.0% total lysine (0.88 TID lysine) content of the feed is recommended for a feed that is provided to pigs for 28 days prior to slaughter on a daily basis and that comprises 4.5 mg ractopamine/kg feed. 1.2% total lysine (1.06 TID lysine) content of the feed is recommended for a feed that is provided to pigs for 28 days prior to slaughter at a daily basis and that comprises 9 mg ractopamine/kg feed.

In case pigs according to science and the label of the manufacturers of the product are fed with 9 mg ractopamine/kg feed, they require an inclusion of 1.2% total lysine (1.06% TID lysine) in their daily applied feed. It has been surprisingly observed that, in case an isoquinoline alkaloid is added to the animal feed in a physiologically active amount, the amount of amino acids in the feed, in particular the amount of lysine, can be reduced significantly to an amount of less than 0.9%, or even less than 0.85% without negatively affecting the physiologic effects of the beta adrenergic agonist:

According to an embodiments, the animal feed comprises at least 4.5 mg of the beta adrenergic agonist, e.g. ractopamine, and comprises lysine in an amount of less than 0.95%, preferably less than 0.9%, more preferably less than 0.85% by weight of the animal feed.

According to an embodiments, the animal feed comprises at least 8.5 mg of the beta adrenergic agonist, e.g. ractopamine, and comprises lysine in an amount of less than 0.90%, preferably less than 0.85%, more preferably less than 0.75% by weight of the animal feed.

According to embodiments, the animal feed supplement is a substance mixture chosen such that, upon being added to an animal feed in a recommended ratio of feed supplement to the (base) animal feed, the resulting substance mixture yields an animal feed according to any one of the embodiments described herein.

In a further aspect, the invention relates to a method for decreasing the amount of protein that needs to be fed to an animal during the application of a beta adrenergic agonist to enable the beta adrenergic agonist to become physiologically effective. The method comprises feeding animals with the animal feed according to one or more of the previous claims.

According to embodiments, the animals are farm animals, in particular pigs, poultry and cattle.

According to embodiments, the animal feed is fed to pigs for raising the weight of each pig at least during the last four weeks before slaughter day. The feed may also be fed for a longer time span, e.g. at least six weeks before slaughter day. Typically, this corresponds to raising the weight of each pig from about 100 kg or from about 85 kg to market weight at slaughter. For example, the liveweight of a pig at slaughter day can be about 135 kg.

According to embodiments, the animal feed is fed to the animals in a time period of at least four weeks prior to slaughter day. This may be advantageous as this may further reduce the costs for the animal feed compared to providing animal feed with the isoquinoline alkaloid and the beta adrenergic agonist for a longer time or for the whole lifetime of the animals.

According to embodiments, the method comprises generating the animal feed by adding the animal feed supplement according to any one of the embodiments described herein to a basic feed component for generating the animal feed of any one of the embodiments described herein. The basic feed preferentially has a lower protein content than recommended for the time period when beta adrenergic agonsists are fed. The added beta adrenergic agonists mobilize fat and fatty acids in the body during the last 4 to 6 weeks of the animals feeding phase prior slaughter. Provided there is sufficient protein in the blood from the animal feed, the beta adrenergic agonist causes the fat metabolism to use the energy in the fat and the amino acids from the feed to form muscle mass. Due to the hormonal mobilization of the body fat by means of the beta adrenergic agonists, the carcass becomes larger, leaner and have a higher lean muscle content.

### DETAILED DESCRIPTION

A standard pig feed formulation AF_{standard230-300} (Cost June 2016: 176 USD/US ton) for the weight section from 230 to 250 US pounds (approximately 100 kg) to the slaughter with 300 pounds (approx. 135 kg) without ractopamine may comprise (% by weight):
69.5% Corn
20% maize products DDGS from ethanol fermentation
8.5% soybean meal
2% minerals, lysine, enzymes and vitamins.

Chemical composition of AF_{standard230-300}:
15.12% protein
0.23% fat
0.75% lysine
0.487% meth+cystine
0.115% tryptophan
0.447% threonine
various minerals and vitamins

A protein-enriched pig feed formulation AFₚᵣₒₜₑᵢₙ₂₃₀₋₃₀₀ (Cost June 2016: 205 USD/US ton) for the weight section from 230 to 250 US pounds (approximately 100 kg) to the slaughter with 300 pounds (approx. 135 kg) with ractopamine may comprise (% by weight):
65.5% corn (4% reduced; relative reduction: −7.7%),
20% maize products DDGS from ethanol fermentation
12.5% soybean meal (4% increased; relative increase: +48%)
2% minerals, lysine, enzymes and vitamins

Chemical composition of AFₚᵣₒₜₑᵢₙ₂₃₀₋₃₀₀:
16.58% protein
4.4% fat
3% fibre material
0.88% lysine
0.519% methionine+cystine
0.135% tryptophan
0.495% threonine
various minerals and vitamins
0.025% Paylean (ractopamin premix)

As can be inferred by a comparison of the costs of AF_{standard230-300} and AFₚᵣₒₜₑᵢₙ₂₃₀₋₃₀₀, the use of Ractopmin increases the cost per US ton of final finisher feed by 29 USD. Thereby, the cost share caused by ractopamine is approximately USD 14 and the cost share caused by the increased protein content is USD 15.

In the last 4 to 6 weeks of factory farming, a pig consumes about 100 kg of food.

The additional cost of the corresponding remanufactured feed with ractopamine is accordingly USD 2.90 per pig (29 USD/to: 100 kg=USD 2.90 per pig).

On the other hand, the use of the ractopamine causes a pig to produce about 3 kg more lean meat. According to market values of lean meat against lower lean contents, this may imply that the carcass of the pig gains in value. In summary, the use of ractopamine results in an economic surplus of ractopamine of about 1.6 to 3.6 USD per pig, depending on current prices for the animal feed components. Embodiments of the invention may improve the cost side of the feed formulation by reducing the necessary increase in the protein content in the feed when feeding ractopamine: typically, a protein content of at least 16.58% is necessary for a ractopamine-based diet. By adding isoquinoline alkaloids to the feed in a sufficient dosage in addition to a beta adrenergic agonist, a protein content of only 15.5% or 16.0% may be sufficient for achieving the same weight and meat quality gain compared to the addition of the beta adrenergic agonist alone.

Experimental results indicate that the digestion, the absorption and the utilization of protein components of the feed can be significantly improved by the combination of isoquinoline alkaloids and beta adrenergic agonists, whereby the effect can lead to a synergistically increased performance of the animals due to the use of the beta adrenergic agonists.

The use of isoquinoline alkaloids in animal feed has been described in detail e.g. in U.S. Pat. No. 7,846,470 B2. However, it was not known that the simultaneous use with beta adrenergic agonists has a significant synergistic effect on performance, in particular in the reduction of fat and gain in lean muscle tissue even in case of a commercial standard or only slightly increased protein content in the feed. The fact that the protein content in the feed can be reduced when feeding beta adrenergic agonists by simultaneously supplementing the feed also with isoquinoline alkaloids without risking the beta adrenergic agonist effects on the meat parameters is an unexpected, surprising effect. Experiments have shown that the use of isoquinoline alkaloids in a dosage of, for example, 0.1 to 5 mg/kg feed results in a better use of the available feed protein for generating lean meat tissue.

It has been observed that if isoquinoline alkaloids are added to the feed, the protein levels do not need to be increased form 8.5% to 12.5%. Rather, an increase to 10.5% or even 10% may be sufficient for achieving the same physiologic effect of the beta adrenergic agonist. Thus, a compareable low increase of the soy bean meal content of the feed, fed during the feeding of the beta adrenergic agonist, in absolute numbers 2%, relatively 25%, instead current adivse of the manufacturers of an increase of 40 to 50% compared to the soy bean meal addition increase that is typically necessary when applying beta adrenergic agonists may be sufficient. Thus, embodiments of the invention enable producers of meat to save 50% of the needed extra protein sources, i.e. the extra dosage of soy bean meal, compared to a feeding of the beta adrenergic agonist alone without the inclusion of the isoquinoline alkaloids.

### First Experiment

The simultaneous use of both substances has a synergistic effect which goes beyond the individual effect of both substances: in a first experiment, a first group of pigs was fed with a mixture of a basic feed and isoquinoline alkaloids alone (which mainly consisted of sanguinarine) during the last 6 weeks until slaughter, a second group of pigs was fed with the same basic feed and a beta adrenergic agonist alone (in this case: ractopamine) and a third group of pigs was fed with the same basic feed and a combination of ractopamine and the isoquinoline alkaloids. It was shown that the pigs in the first group improved their share of lean meat by about 2% and the total body weight by approx. 2.5%. The feed utilization in the first group was improved by approx. 3%. The pigs in the second group improved their share of lean meat by about 4% and the total body weight by approx. 0.5%. The feed utilization in the second group was improved by approx. 5%. The pigs in the third group where both substances, the isoquinoline alkaloids and the beta adrenergic agonist, had been combined, improved their share of lean meat by about 7% and the total body weight by approx. 10%. The feed utilization in the third group was improved by approx. 8%. These results show that the combined use of both substances in pigs during the last 4 to 6 weeks leads to a significantly synergistic performance gain which significantly exceeds the expected gain in body weight and lean meat of the two substances given individually.

| | | gain in total | |
|---|---|---|---|
| | gain in lean | body weight | Improved |
| | meat during last | during last | feed |
| | 6 weeks | 6 weeks | utilization |
| Group I | 2% | 2.5% | 3% |
| AFₚᵣₒₜₑᵢₙ₂₃₀₋₃₀₀ + | | | |
| isoquinoline alkaloids | | | |
| (1 mg/kg) | | | |
| Group II | 4% | 0.5% | 5% |
| AFₚᵣₒₜₑᵢₙ₂₃₀₋₃₀₀ + | | | |
| ractopamine(7.5 mg/kg) | | | |
| Group III | 7% | 10% | 8% |
| AFₚᵣₒₜₑᵢₙ₂₃₀₋₃₀₀ + | | | |
| isoquinoline alkaloids | | | |
| (1 mg/kg) + | | | |
| ractopamine(7.5 mg/kg) | | | |

### Second Experiment

In the second experimental test, 4 groups of 50 pigs were fed with different food and additive combinations for 4 weeks until slaughter day as presented in the table below. The Isoquinoline alkaloids in the feed of groups 2 and 3 mainly consisted of sanguinarine.

| | | | Group 3 | |
|---|---|---|---|---|
| | | | isoquinoline | |
| | | Group 2 | alkaloids 1 | Group 4 |
| | | (isoquinoline | mg/kg feed + | ractopamin |
| | Group 1 | alkaloids, | ractopamin 7.5 | 7.5 mg/kg |
| | (control) | 1 mg/kg feed) | mg/kg feed | feed |
| live mass 4 weeks | 95.5 | 95.0 | 95.0 | 95.5 |
| before slaughter | | | | |
| day [kg] | | | | |
| live mass at | 118 | 125 | 126.5 | 125.5 |
| slaughter day [kg] | | | | |
| Daily weight | 753 | 842 | 895 | 852 |
| gain [g] | | | | |
| Feed conversion | 2.78 | 2.67 | 2.55 | 2.62 |
| ratio: | | | | |
| Basic feed | 75% corn, | 75% corn, | 73% corn, | 70% corn, |
| composition | 15% soybean, | 15% soybean, | 17% soybean | 20% soybean |
| | 8% millet, | 8% millet, | 8% millet | 8% millet |
| | 2% vitamins | 2% vitamins | 2% vitamins | 2% vitamins |
| | and minerals | and minerals | and minerals | and minerals |
| Fraction lean | 54.95 | 55.90 | 59.3 | 58.5 |
| meat [%] | | | | |

Results: The sole use of isoquinoline alkaloids like sanguinarine in an unchanged feed formulation (group 2) improves the performance in daily weight gain during the finisher phase significantly compared with the control group (group 1) and reduces feed costs. The proportion of lean meat is increased.

The use of the beta adrenergic agonist ractopamine with 7.5 mg per kg of feed combined with a 40% increase in soybean content in the feed (group 4) relative to the soybean content of the feed of the control group significantly improves performance and increases the lean meat content and the feed utilization.

The pigs of group 3 are fed with a feed comprising a combination of isoquinoline alkaloids and beta adrenergic agonist and comprising a proportion of soybean that is only 2% higher than the soja portion of the feed of the control group show a significant increase in the daily weight gains, feed utilization and the lean meat content.

The feed formula for group 3 is about 5 to 7 USD per US tonne cheaper than the feed formula of the feed mixture of group 4 with the beta adrenergic agonist alone, depending on the market price. The use of the combination improves feed conversion, daily growth and the lean meat content (group 3) compared to the use of the beta adrenergic agonist alone (group 4) as well as compared to the use of isoquinoline alkaloids alone (group 2) and leads to a monetary advantage of approx. 5 USD per pig compared with the feed for group 3 and more than 6 USD compared with the control group depending on the market prices.

### Third Experiment

The following table illustrates meat quality indicators obtained for 120 pigs fed for the last four weeks until slaughter day added with a beta adrenergic agonist at recommended dosages of 7.5 mg/kg feed and having a protein enriched feed formulation comparing to 120 other pigs fed during the same time period with the same feed which in addition the the beta adrenergic agonist is also added with isoquinoline alkaloids like sanguinarin.

In most countries of the world, the quality of the carcass (without innards and blood) is determined as of muscle area, fat mm at back, total analysis of fat content etc. for determining the price of the carcass per kg warm or cold carcass weight (depending on country). For this purpose, the animals are scanned in the slaughtering line by means of sensors or image-giving techniques, and the proportion of muscles and the thickness of the backbone are measured and converted into an equation which then calculates the proportion of lean meat in the entire carcass. In the EU, the carcasses can be assigned to different meat quality groups according to the following classification scheme:
S=Highest quality=>60.85% lean-meat
E=Premium Quality=58.75% lean-meat
U=High Quality=>55.9% lean-meat
R=Medium Quality=>53.9% lean-meat
O=Low Quality=>51.1% lean-meat
P=very low Quality=<51.1% lean-meat

| | | | | 120 pigs fed with isoquinoline | |
|---|---|---|---|---|---|
| Meat quality | | 120 pigs fed with | | alkaloids (mainly | |
| indicators | | ractopamin | | sanguinarine) + ractopamin | |
| Meat quality | % lean- | Number | % of all | Number | % of all |
| classes | meat | of pigs | pigs | of pigs | pigs |
| S | >60.85 | 40 | 33 | 54 | 45 |
| E | >58.75 | 49 | 41 | 42 | 35 |
| U | >55.90 | 23 | 19 | 15 | 13 |
| R | >53.90 | 7 | 6 | 7 | 6 |
| O | >51.10 | 1 | 1 | 2 | 2 |
| P | <51.10 | 0 | 0 | 0 | 0 |

The meat quality indicators and the distribution of pigs assigned to different meat quality classes clearly indicate that a combination of isoquinoline alkaloids and beta adrenergic agonist significantly increases meat quality by enriching the numbers of S and E carcass classes as highest value carcasses from 74% in the beta adrenergic agonist group against 80% in the group where the combination of beta adrenergic agonist and isoquinoline alkaloids had been fed. With other words, the combination delivery 6 pigs out of 100 more into the high value carcasses than the feeding of the beta adrenergic agonist alone.

### Fourth Experiment

As a rule, during the last 4-week before slaughter day when beta adrenergic agonists are typically administered, an animal feed is administered which not only has a higher protein content but also a higher proportion of muscle-binding amino acids (e.g., lysine). For example, a manufacturer of a beta adrenergic agonist prescribes that the content of the limiting amino acid lysine and threonine in the feed must be about 30% higher than under “standard” conditions when the beta adrenergic agonist is administered. It is, however, known that only 30% of the amino acids added to the feed are resorbed and metabolized, the rest being lost.

The test was performed with 1500 pigs divided into four groups 1-4, each group comprising 375 pigs. The pigs were held in 100 units of 15 animals per unit. Different groups of pigs were fed with feeds of different compositions. The following table illustrates meat quality indicators.

The following animal feed compositions were administered:
AFC1: Corn, maize, soybean meal, vitamine, enzyme and mineral mixture comprising: 17% protein 0.8% lysine
AFC2: Corn, maize, Corn, maize, soybean meal, vitamine, enzyme and mineral mixture comprising: 17% protein, 0.8% lysine and 1 mg isoquinoline alkaloid/kg feed (mainly sanguinarine)
AFC3: Corn, maize, soybean meal, vitamine, enzyme and mineral mixture comprising: 19% protein, 1% lysine and a beta adrenergic agonist (ractopamin as “Paylean®” in recommended dosage (®=reg. trademark of Eli Lilly and Co.)
AFC4: Corn, maize, soybean meal, vitamine, enzyme and mineral mixture comprising: 17% protein, 0.9% lysine, 1 mg isoquinoline alkaloid (mainly sanguinarine)/kg feed and a beta adrenergic agonist (ractopamin as “Paylean®” Paylean in recommended dosage)

| | Distribution of slaughtered pigs in the meat quality classes in % | | | |
|---|---|---|---|---|
| | | | | Group 4 |
| | | | Group 3 | isoquinoline |
| Meat | Group 1 | Group 2 | beta adrenergic | alkaloid + |
| quality | Control | isoquinoline | agonist as | ractopamine |
| class | group | alkaloid | “(“Paylean ®”) | (“Paylean ®”) |
| animal | AFC1 | AFC2 | AFC3 | AFC4 |
| feed | | | | |
| S | 35 | 33 | 38 | 47 |
| E | 35 | 41 | 39 | 35 |
| U | 15 | 19 | 20 | 12 |
| R | 10 | 6 | 2 | 4 |
| O | 4 | 1 | 1 | 2 |
| P | 1 | 0 | 0 | 0 |

The distribution of the carcasses classified as “S” and “E” quality is as follows:

| | % of all pigs | Net economic benefit |
|---|---|---|
| | distributed in | per pig (all pigs) relative |
| | classes | to control group after |
| | S and E | paying costs of the additives |
| Group 1 (Control) | 70% | |
| Group 2 (isoquinoline | 74% | 2 € per pig |
| alkaloid) | | |
| Group 3 (beta adrenergic | 77% | 4 € per pig |
| agonist as “Paylean ®”) | | |
| Group 4 (isoquinoline | 82% | 8 € per pig |
| alkaloid + beta adrenergic | | |
| agonist as “Paylean ®”) | | |

Thus, the combined administration of an isoquinoline alkaloid and a beta adrenergic agonist may also allow reducing the concentration of amino acids in the animal feed without reducing the positive physiological effects of the beta adrenergic agonist.

### Fifth Experiment

Test four was repeated with 1700 pigs of a different farm divided into four groups 1-4, each group comprising 425 pigs. The pigs were held in units of 25 animals. Different groups of pigs were fed with feeds of different compositions as described for the fourth experiment. The following table illustrates meat quality indicators.

| | Distribution of slaughtered pigs in the meat quality classes in % | | | |
|---|---|---|---|---|
| | | | | Group 4 |
| | | | Group 3 | isoquinoline |
| Meat | Group 1 | Group 2 | beta adrenergic | alkaloid + beta |
| quality | Control | isoquinoline | agonist as | adrenergic agonist |
| class | group | alkaloid: | “Paylean ®” | as “Paylean ®” |
| animal | AFC1 | AFC2 | AFC3 | AFC4 |
| feed | | | | |
| S | 26 | 26 | 40 | 58 |
| E | 30 | 40 | 35 | 34 |
| U | 25 | 21 | 15 | 5 |
| R | 15 | 10 | 8 | 3 |
| O | 4 | 3 | 2 | 0 |
| P | 0 | 0 | 0 | 0 |

The distribution of the carcasses classified as “S” and “E” quality is as follows:

| | | Net economic benefit |
|---|---|---|
| | | per pig (all pigs) relative |
| | % of all | to control group after |
| | pigs | paying costs of the additives |
| Group 1 (Control) | 56% | |
| Group 2 (isoquinoline | 66% | 3 € per pig |
| alkaloid) | | |
| Group 3 (beta adrenergic | 75% | 6 € per pig |
| agonist as “Paylean ®”) | | |
| Group 4 (isoquinoline | 92% | 12 € per pig |
| alkaloid + beta adrenergic | | |
| agonist as “Paylean ®”) | | |

### Sixth Experiment

Test four was repeated with 1310 pigs of a further animal farm divided into four groups 1-4, each group comprising 330 pigs. The pigs were held in 11 units of 30 animals. Different groups of pigs were fed with feeds of different compositions as described for the fourth experiment. The following table illustrates meat quality indicators.

| | Distribution of slaughtered pigs in the meat quality classes in % | | | |
|---|---|---|---|---|
| | | Group 2 | | Group 4 |
| | | isoquinoline | Group 3 | isoquinoline |
| | | alkaloid | beta | alkaloid (mainly |
| Meat | Group 1 | (mainly | adrenergic | sainguinarine) + |
| quality | Control | saingui- | agonist as | beta adrenergic |
| class | group | narine) | “Paylean ®” | agonist as “Paylean ®” |
| animal | AFC1 | AFC2 | AFC3 | AFC4 |
| feed | | | | |
| S | 30 | 31 | 40 | 50 |
| E | 33 | 41 | 38 | 35 |
| U | 22 | 20 | 18 | 10 |
| R | 11 | 8 | 3 | 5 |
| O | 4 | 0 | 1 | 0 |
| P | 0 | 0 | 0 | 0 |

The distribution of the carcasses classified as “S” and “E” quality is as follows:

| | | Net economic benefit |
|---|---|---|
| | | per pig (all pigs) relative |
| | % of all | to control group after |
| | pigs | paying costs of the additives |
| Group 1 (Control) | 63% | |
| Group 2 (isoquinoline | 72% | 3 € per pig |
| alkaloid) | | |
| Group 3 (beta adrenergic | 78% | 5 € per pig |
| agonist as “Paylean ®”) | | |
| Group 4 (isoquinoline | 85% | 10 € per pig |
| alkaloid + beta adrenergic | | |
| agonist as “Paylean ®”)) | | |

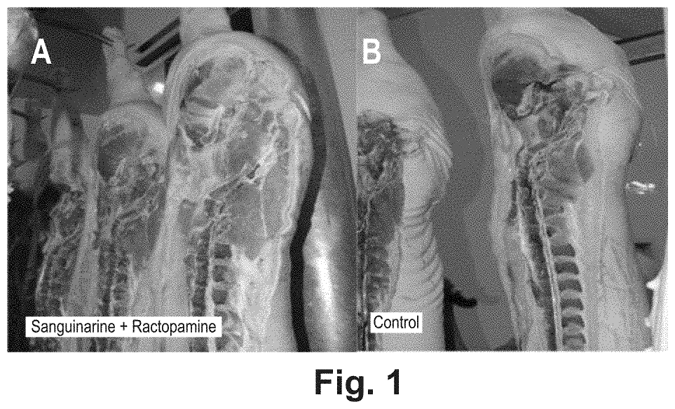

FIG. 1A shows the carcasse of a pig that was finished with an animal feed mixture comprising an isoquinoline alkaloid (here: sanguinarine) and a beta adrenergic agonist ractopamine (“Paylean®”) according to an embodiment of the invention.

FIG. 1B shows the carcasse of a pig that was finished with a standard animal feed mixture comprising neither the sanguinarine nor ractopamine (nor any other isoquinoline alkaloid or beta adrenergic agonist). The carcasse depicted in FIG. 1A comprises a significantly thinner subcutaneous fat tissue than the carcasse depicted in FIG. 1B.

1. An animal feed or an animal feed supplement comprising a combination of an isoquinoline alkaloid and a beta adrenergic agonist.

2. The animal feed or animal feed supplement of claim 1 for use in decreasing the amount of protein that needs to be fed to an animal during the application of a beta adrenergic agonist to enable the beta adrenergic agonist to become physiologically effective.

3. The animal feed or animal feed supplement of any claim 1, the isoquinoline alkaloid being selected from a group comprising sanguinarine, chelerythrine, chelirubin, sanguirubin, chelilutin, sanguilutin, berberin, protopin, allocryptopin and physiologically acceptable salts of these compounds.

4. The animal feed or animal feed supplement of claim 1 comprising a plant extract of a Macleaya species, in particular Macleaya cordata, or of a Sanguinaria species, in particular Sanguinaria Canadensis, the plant extract comprising a mixture of two or more of the isoquinoline alkaloids or isoquinoline alkaloid salts according to any one of the previous claims.

5. The animal feed or animal feed supplement of previous claim 1, the beta adrenergic agonist being ractopamin or zilpaterol.

6. The animal feed or animal feed supplement of claim 1 having a weight ratio of ractopamine to the isoquinoline alkaloid from 150:1 to 0.4:1.

7. The animal feed of claim 1 comprising an amount of at least 0.01 mg isoquinoline alkaloid per kg of the animal feed, preferably of at least 0.1 mg isoquinoline alkaloid per kg of the animal feed.

8. The animal feed of claim 1 comprising an amount of 2 to 15 mg of the beta adrenergic agonist per kg of the animal feed, in particular 6 to 9 mg of the beta adrenergic agonist per kg of the animal feed.

9. The animal feed of claim 1 comprising an amount of at least 4.5 mg of the beta adrenergic agonist per kg of the animal feed, and comprising lysine in an amount of less than 0.90%, preferably less than 0.85%, preferably less than 0.75% by weight of the animal feed.

10. The animal feed of claim 1 comprising an amount of at least 8.5 mg of the beta adrenergic agonist per kg of the animal feed, and comprising lysine in an amount of less than 1.0%, preferably less than 0.95%, preferably less than 0.90% by weight of the animal feed.

11. The animal feed of claim 1 containing corn in an amount of 51%-80%, in particular between 65 and 70% by weight of the animal feed.

12. The animal feed of claim 1 containing soybean meal in an amount of not more than 14% by weight of the animal feed.

13. The animal feed of claim 1 containing soybean meal in an amount of 10%-12%, in particular 10-11% by weight of the animal feed.

14. The animal feed of claim 1 containing DDGS in an amount of 10%-22%, in particular 16% to 20% by weight of the animal feed.

15. The animal feed of claim 1 comprising protein in an amount of less than 16.5% by weight of the animal feed, preferably less than 15.8% by weight of the animal feed, preferably less than 15% by weight of the animal feed.

16. (canceled)

17. A method for decreasing the amount of protein that needs to be fed to an animal during the application of a beta adrenergic agonist to enable the beta adrenergic agonist to become physiologically effective, the method comprising:
feeding animals with the animal feed or animal feed supplement according to claim 1.

18. The method of claim 17, the animal feed being fed to pigs for raising the weight of each pig at least during the last four weeks before slaughter day.

19. (canceled)
